(19) United States
(12) Patent Application Publication
(10) Pub. No.: US 2024/0245070 A1
(43) Pub. Date: Jul. 25, 2024

(54) PROCESSING OF SEEDS OF FRUIT

(71) Applicant: Ferdinand VAN HEERDEN, Berlin (DE)

(72) Inventor: Ferdinand VAN HEERDEN, Berlin (DE)

(21) Appl. No.: 18/564,269

(22) PCT Filed: May 27, 2022
(86) PCT No.: PCT/IB2022/055016

§ 371 Date: Nov. 27, 2023

(30) Foreign Application Priority Data
May 27, 2021 (ZA) 2021/03610

(51) Int. Cl. A23G 1/06; A23G 1/02; B65D 33/16; B65D 77/22; B65D 81/26; G06Q 50/02

(52) U.S. Cl. CPC A23G 1/06; A23G 1/02; B65D 33/1658; B65D 77/225; B65D 81/264; G06Q 50/02; B65D 2201/00; B65D 2203/10

(57) ABSTRACT

This invention relates to the processing and tracing of harvested seeds of fruit. More specifically, this invention relates to a seed processing system 100 comprising a seed processing container 10, 10.1 which includes a housing 12 defining a cavity 14 and an opening 15 that is in communication with the cavity 14; a closure 16 displaceable between an open position wherein the opening 15 is open and the seeds of fruit can be placed in or removed from the cavity 14, and a closed position wherein the opening 15 is closed to form a closed cavity 14 and the seeds of fruit cannot be placed in or removed from the cavity 14; and a closure sensor 17 for sensing when the closure 16 is displaced to its closed position, and generating closure position data in response to sensing displacement of the closure 16 to its closed position.

### FIELD OF THE INVENTION

This invention relates to the processing and tracing of harvested seeds of fruit. More particularly, but not exclusively, this invention relates to a seed processing system for processing seeds of fruit such as, for example, cacao beans and coffee beans. The invention also extends to a method of processing seeds of fruit and to a seed processing container.

### BACKGROUND TO THE INVENTION

Cacao beans are the principal raw material for chocolate production. These beans are derived from the fruit pods of the Theobroma cacao tree, which is cultivated most successfully on farms in the equatorial zone. Raw cacao beans have an astringent, unpleasant taste and flavour, and have to be fermented, dried, and roasted to obtain the desired characteristic cocoa flavour and taste.

Cacao beans form the basis of chocolate whose flavour and quality are influenced by the origin of the cacao beans, the cacao cultivar, the at source fermentation and drying processes, and the roasting and further processing performed by the chocolate manufacturer. Among these, the fermentation of the cacao beans is arguably the most important process to enhance its flavour quality since it is the process whereby the precursors of the cacao flavour arise.

Current post-harvest best-practices followed on farms and plantations comprise the steps of opening and removing the beans from the pod, and subsequently subjecting them to anaerobic fermentation, and/or aerobic fermentation, and/or finally solar drying. The fermentation constitutes an essential step for the development of flavour quality and directly affects the value of the beans.

Controlled anaerobic fermentation is however only occasionally practised as part of the post-harvesting process. Currently, in Africa, the cacao beans are often fermented under uncontrolled open conditions in the field or forest, where the beans hardly attain the temperatures needed for ideal fermentation and bean flavour maturation. These open fermentation piles are also susceptible to damage caused by animals and fungal or other infections. As such the value of the beans is lower compared to beans that underwent true anaerobic fermentation in a controlled environment.

Cacao production is also a highly labour-intensive industry and due to the nature of the Theobroma cacao tree and remote areas where they are grown, the harvesting of the fruit pods cannot easily be mechanised. This has led to a highly artisanal and fragmented industry. The harvesting of cacao thus often takes place with little or no oversight of human rights and environmental standards which has resulted in the cacao harvesting industry being rife with child labour, human slavery, and wholesale environmental destruction. Chocolate companies currently are able to trace the origin of only a portion of cacao they use, and as such are not able to determine, for example, whether child labour or slavery was used in its production, its impact on deforestation, or the like.

Transparency and traceability of cacao harvesting is also an important factor in increasing accountability and sustainability of the chocolate and cacao sector. Reference is made to IDH, GISCO, C-lever.org, 2021: Technical Brief on Cocoa Traceability. P. Stoop, N. Ramanan, H. Geens, A. Lambrecht and S. Dekeisterwhich relates to transparency and traceability of Cocoa the entire content of which is incorporated herein by reference.

Furthermore, the European Union (EU) has recently released draft legislation that will shift the due diligence responsibility to prove source of origin onto European confectioners and traders.

The aim of the new rules is to prevent deforestation, forest degradation and to reduce carbon emissions to the atmosphere every year due to EU consumption and production of the relevant commodities.

Companies placing the relevant commodities and products on the market will be required to put in place and implement due diligence systems to prevent the placing on the EU market of products linked to deforestation. They will be monitored and held accountable by enforcing authorities if they fail to comply with the requirements of the Regulation. Companies will need to submit a statement to a European information system confirming that they have successfully exercised due diligence and that the products they place on the market are compliant with EU rules.

### OBJECT OF THE INVENTION

It is accordingly an object of the present invention to provide a seed processing system for processing seeds of fruit, a method of processing seeds of fruit, and a seed processing container which seeks to, at least partially, overcome the abovementioned drawbacks, and/or which provides a useful alternative to current fruit seed processing practices and means.

### SUMMARY OF THE INVENTION

According to a first aspect of the present invention, there is provided a seed processing system suitable for processing seeds of fruit, the system comprising a seed processing container including:
a housing defining a cavity and an opening that is in communication with the cavity;
a closure displaceable between an open position wherein the opening is open and seeds of fruit can be placed in or removed from the cavity, and a closed position wherein the opening is closed to form a closed cavity and the seeds of fruit cannot be placed in or removed from the cavity;
a closure sensor for sensing when the closure is displaced to its closed position, and generating closure position data in response to sensing displacement of the closure to its closed position;
geographical location tracking means for generating location data relating to a geographical location of the container when the closure closes the opening;
a time module for generating time data relating to a time when the closure closes the opening;
a memory arrangement for storing the location and time data; and
a data transfer module for transferring any one or both of the location data and time data for receipt by a remote data receiver.

There is provided for the closed cavity to be sufficiently air-tight to provide preconditions for anaerobic fermentation of the seeds of fruit in the cavity.

The closure sensor may be configured to sense when the closure is displaced to its open position, and to generate the closure position data in response to said sensing. The closure sensor may further be configured to transmit a digital signal including the closure position data, and the closure position data includes information relating to a binary state, specifically the open or closed position of the closure.

The geographical location tracking means may comprise a receiver of a satellite-based navigation system which is configured to receive a location signal broadcasted from one or more satellites in a Global Navigation Satellite System with the geographical location tracking means configured to generate therefrom the location data. It is envisaged that in some embodiments of the invention, the receiver of the geographical location tracking means may be configured to receive location data from any other universal geographical referencing means.

There is also provided for the geographical location tracking means to generate location data relating to a geographical location of the container when the closure opens the opening.

In at least some embodiments of the invention, the time module may generate time data relating to a time when the closure opens the opening. Preferably, the time module may derive the time data from the location signal.

The data transfer module is configured to transfer the data via a wireless or wired communication path. In the case of a wireless communication path, the data may be transmitted via any suitable communication protocol or standard, including Near Field Communication (NFC), Bluetooth®, Global System for Mobile Communications (GSM), Wi-Fi or the like.

The container may further include a temperature sensor for generating temperature data relating to a temperature within the closed cavity, wherein the system is configured for the memory arrangement to store the temperature data and the data transfer module to transfer the temperature data for receipt by the remote data receiver

The temperature sensor may generate the temperature data at predetermined time intervals.

The invention provides for the container to include a unique identifier pertaining to an identity of the container, wherein the system is configured for the data transfer module to transfer the unique identifier for receipt by the remote data receiver. In a preferred embodiment, the unique identifier may be in the form of a media access control address (MAC address). In addition, or in the alternative, the unique identifier may be in the form of identifying indicia. The identifying indicia may be in the form of an optical label, preferably in the form of a machine-readable optical label.

In at least some embodiments of the invention, the container may further comprise micro-climate regulation means for regulating at least one climate condition in the closed cavity. The at least one climate condition may include, but not limited to, any one or both of a moisture quantity and pressure. Preferably, micro-climate regulation means may extend from the cavity to an outside of the container.

The container may further include a fermentation conducer to conduce fermentation of the seeds of fruit in the cavity.

In a preferred embodiment of the invention, the system includes a database that is remote from the container and in data communication with the remote data receiver, said database including information relating to the container and at least one party in possession of the container.

The information relating to the container may include any one or more selected from the group comprising a unique identifier, the location data, the time data, temperature data, and a measured weight. Furthermore, the information relating to at least one party in possession of the container may include any one or more selected from the group comprising identification information of the party, a time and/or date when the party is in possession of the container, an address of an area of land associated with the party, the size of the area of land, a harvesting quota associated with the party, and banking details of the party.

In one example embodiment, the housing may be in the form of an at least partially flexible housing with the closure in the form of a fastener. In another example embodiment, the housing may be in the form of a rigid housing with the closure in the form of a rigid lid.

According to a second aspect of the invention, there is provided a seed processing container as defined above.

According to a third aspect of the present invention, there is provided a method of processing seeds of fruit, including the steps of:
placing the seeds in a cavity of a container;
closing the cavity to form a closed cavity;
on the container, generating location data relating to a geographical location of the container when the cavity is closed;
on the container, generating time data relating to a time when the cavity is closed; and
allowing the seeds to ferment in the closed cavity under anaerobic conditions for a first period of time.

Closing of the cavity may form a sufficiently air tight cavity to provide preconditions for anaerobic fermentation of the seeds therein.

The first period of time may be less than 6 weeks. More specifically, the first period of time may be between 12 hours and 14 days. Even more specifically, the first period of time may be between 2 and 7 days.

Closure of the cavity may cause the location and time data to be automatically generated.

There is further provided for, on the container, generating temperature data relating to a temperature within the closed cavity. The temperature data may be generated at predetermined time intervals.

A further step may involve regulating at least one climate condition in the closed cavity, said at least one climate condition including any one or both of a moisture quantity and pressure.

The method may also include the step of placing in the cavity a fermentation conducer to conduce fermentation of the seeds of fruit in the cavity.

The method may involve transferring from the container to a remote data receiver any one or more of the location data, time data, temperature data, and a unique identifier of the container.

In a preferred embodiment, the method may involve recording on a database that is remote from the container, information relating to the container and at least one party in possession of the container.

The information relating to the container may include any one or more selected from the group comprising a unique identifier, the location data, the time data, and a measured weight. The information relating to at least one party in possession of the container may include any one or more selected from the group comprising identification information of the party, a time and/or date when the party is in possession of the container, an address of an area of land associated with the party, the size of the area of land, a harvesting quota, and banking details of the party.

The method may include the subsequent steps of opening the container and permitting the seeds to ferment under aerobic conditions for a second period of time.

Some embodiments of the invention may include the following steps:
on the container; generating the location data relating to a geographical location of the container when the cavity is opened; and
on the container, generating the time data relating to a time when the cavity is opened.

The second period of time may be less than 2 weeks. More specifically, the second period of time may be between 1 and 9 days. Even more specifically, the second period of time may be between 2 and 5 days.

The method may include the further subsequent step of drying the seeds.

These and other features of the invention are described in more detail below.

### BRIEF DESCRIPTION OF THE ACCOMPANYING DRAWINGS

Embodiments of the invention are described below, by way of non-limiting examples only and with reference to the accompanying drawings in which:

FIG. 1 is a schematic block and line diagram of a system suitable for processing seeds of fruit, in accordance with a first aspect of the invention;

FIG. 2 shows a schematic front view of a seed processing container for processing seeds of fruit, forming part of the system shown in FIG. 1, and in accordance with a first embodiment of a second aspect of the invention;

FIG. 3 is a schematic front view of the container of FIG. 2 with a cavity of the container closed;

FIG. 4 shows a schematic front view of a seed processing container for processing seeds of fruit, forming part of the system shown in FIG. 1, and in accordance with a second embodiment of the second aspect of the invention;

FIG. 5 is a schematic diagram of a further aspect of the system shown in FIG. 1; and

FIG. 6 is a schematic flow chart of a method of processing seeds of fruit, according to a third aspect of the invention.

### DETAILED DESCRIPTION OF EXAMPLE EMBODIMENTS OF THE INVENTION

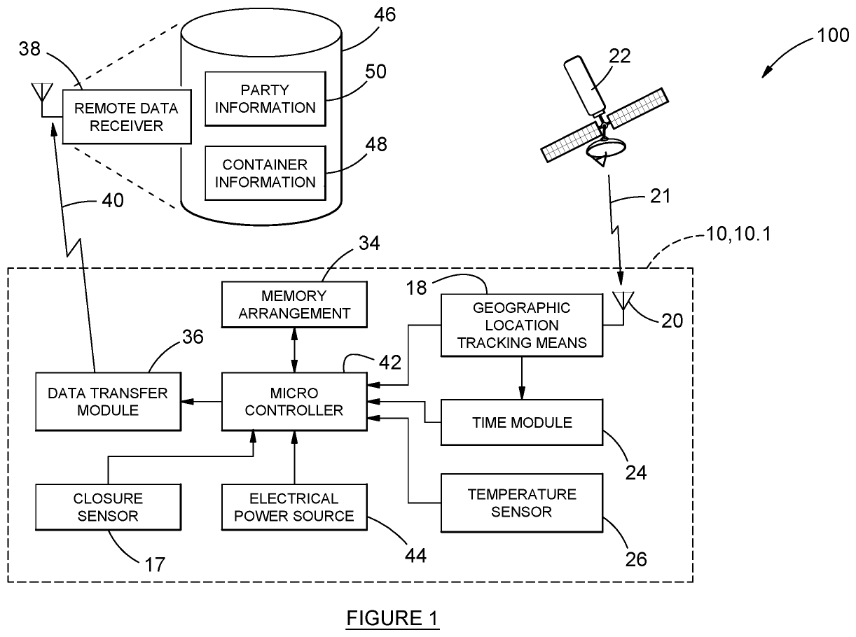

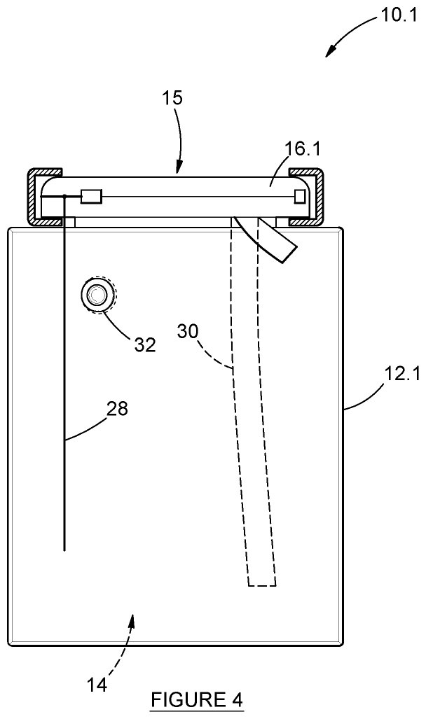

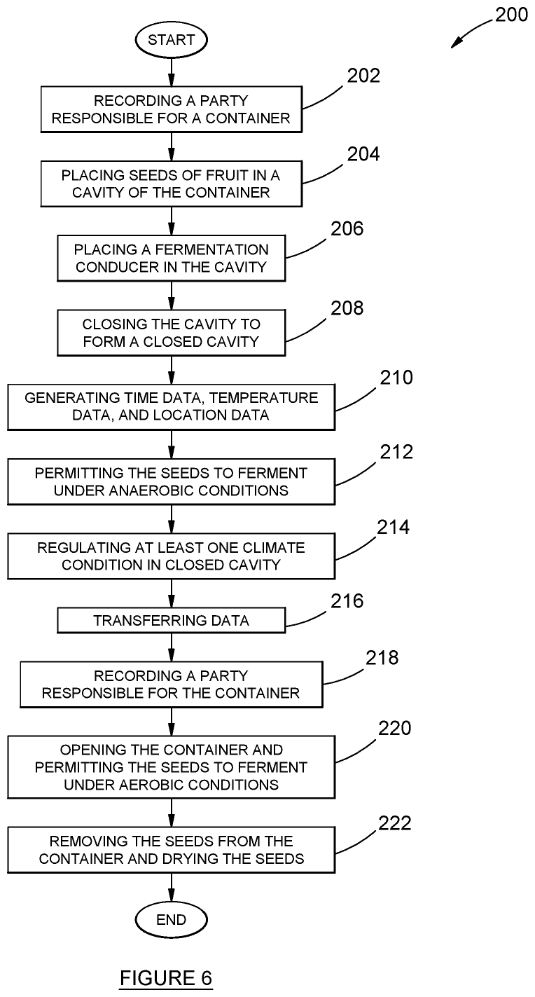

With reference to the Figures, in which like numerals refer to like features, a seed processing system suitable for processing seeds of fruit, according to a first aspect of the invention, is generally designated by reference numeral 100 in FIGS. 1 and 4, a seed processing container for processing seeds of fruit in accordance with a first embodiment of a second aspect of the invention is generally indicated by reference numeral 10 in FIGS. 1-3 and 5, a seed processing container for processing seeds of fruit in accordance with a second embodiment of the second aspect of the invention is generally indicated by reference numeral 10.1 in FIGS. 1, 4 and 5, and a method of processing seeds of fruit according to a third aspect of the invention is generally indicated by reference numeral 200 in FIG. 6.

The system 100 comprises at least one seed processing container 10, 10.1. In a preferred embodiment of the invention, the system 100 comprises a plurality of seed processing containers 10, 10.1. The containers 10, 10.1 are similar and hence for ease of description only a single container 10, 10.1 will be described further below.

Each container 10,10.1 includes a housing 12, 12.1 which defines a cavity 14 for receiving therein seeds of fruit (not shown) for fermentation, and an opening 15 that is in communication with the cavity 14. The seeds of fruit may be any seeds of fruit which is known in the art. Specifically, the seeds of fruit may be cacao/cocoa beans or coffee beans. The terms cacao and cocoa are used interchangeably in this specification and reference to one includes reference to the other.

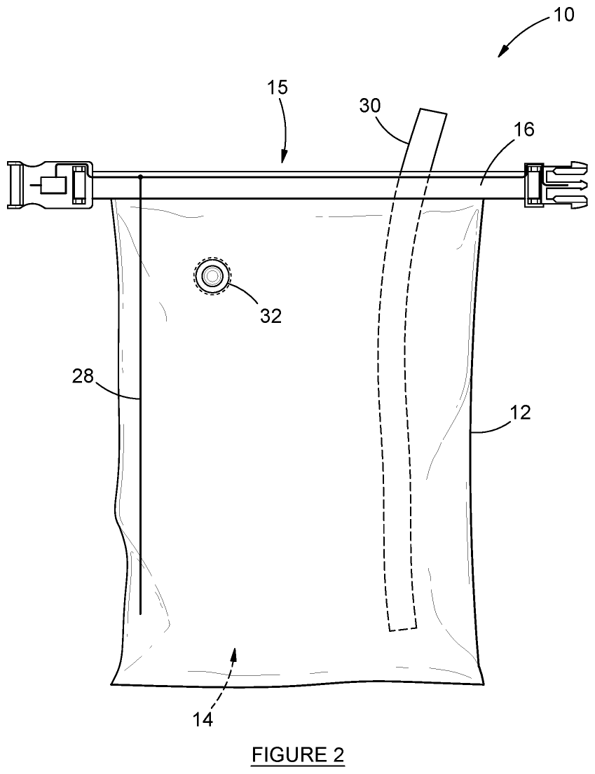

It will be appreciated that the housing 12, 12.1 may be in any suitable form and that the housing 12, 12.1 described according to these example embodiments are provided merely for the purposes of explanation. As shown in FIG. 1, the housing 12 is in the form of an at least partially flexible housing 12, and as shown in FIG. 2, the housing 12.1 is in the form of a rigid housing 12.1.

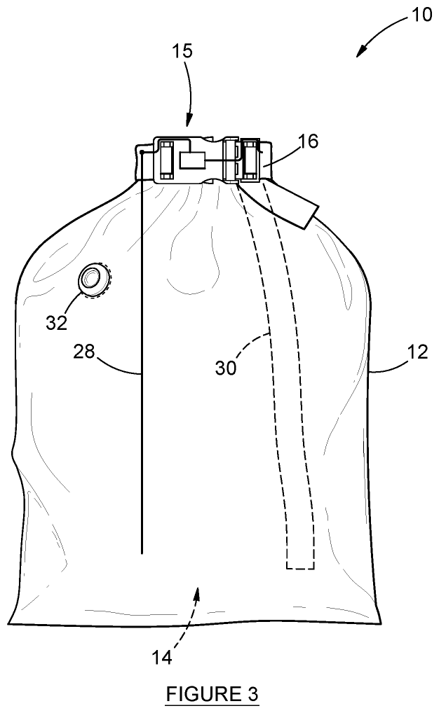

The container 10, 10.1 comprises a closure 16 for closing the cavity 14 to form a sufficient air tight cavity which allows for the anaerobic fermentation of the seeds of fruit located therein. More specifically, the closure 16 is displaceable between an open position (shown in FIG. 2) wherein the opening 15 is open and the seeds of fruit can be placed in or removed from the cavity 14, and a closed position (shown in FIG. 3) wherein the opening 15 is closed to form a closed cavity 14 and the seeds of fruit cannot be placed in or removed from the cavity 14. In the first embodiment where the housing 12 is in the form of an at least partially flexible housing, the closure 16 is in the form of a fastener such as a clasp. In the second embodiment where the housing 12.1 is in the form of a rigid housing, the closure 16 is in the form of a rigid lid 16.1.

A closure sensor 17 is also included in the container 10, 10.1 for sensing when the closure 16 is displaced to its closed position, and generating closure position data in response to sensing displacement of the closure 16 to its closed position. The closure sensor 17 is also configured to sense when the closure 16 is displaced to its open position, and to generate closure position data in response to said sensing. The closure sensor 17 is configured to transmit a digital signal including the closure position data; wherein the closure position data includes information relating to a binary state, specifically the open or closed position of the closure 16.

The container 10, 10.1 also includes geographical location tracking means 18 for generating location data relating to a geographical location of the container 10,10.1 when the closure 16 closes the opening 15. Furthermore, in some embodiments of the invention, the geographical location tracking means 18 generates location data relating to a geographical location of the container 10, 10.1 when the closure 16 opens the opening 15.

The geographical location tracking means 18 may be of any kind which is known in the art. In a preferred embodiment, the geographical location tracking means comprises a receiver 20 of a satellite-based navigation system which is configured to receive a location signal(s) 21 broadcasted from one or more satellites 22 in a Global Navigation Satellite System, with the geographical location tracking means 18 configured to generate the location data from the location signal 21.

The container 10,10.1 further comprises a time module 24 for generating time data relating to a time when the closure 16 closes the opening 15. Furthermore, in some embodiments, the time module 24 generates time data relating to a time when the closure 16 opens the opening 15. The time module 24 derives the time data from the location signal 21 transmitted by the one or more satellites 22. Here, the time includes any one or more selected from the group comprising point in time as measured in hours and minutes, a day of the months, and a year.

The container 10, 10.1 also comprises a temperature sensor 26 for generating temperature data relating to a temperature within the closed cavity 14. The temperature sensor 26 is capable of generating the temperature data at predetermined time intervals. The temperature sensor 26 could be of any kind which is known in the art. In the example embodiment, the temperature sensor 26 includes a temperature probe 28 which is operatively placed within the cavity 14 to sense temperature within the cavity 14 and generate the temperature data relating to the sensed temperature.

The container 10, 10.1 further comprises micro-climate regulation means for regulating at least one climate condition in the closed cavity 14. The at least one climate condition includes any one or both of a moisture quantity and pressure. The micro-climate regulation means extends from the cavity 14 to an outside of the container 10, 10.1. More specifically, the micro-climate regulation means comprises a moisture regulating element 24 which is configured to extract moisture from the cavity 14, or add moisture to the cavity 14, whilst the cavity 14 is in a closed state. The moisture extraction means 24 in this specific example is in the form of an elongated wicking element. Also, the micro-climate regulation means comprises a pressure regulating element 32 which is configured to prevent the pressure inside the closed cavity 14 from exceeding a predetermined threshold. The pressure regulating element 32 in this specific example is in the form of a pressure relief valve.

In some embodiments, the container 10, 10.1 includes a fermentation conducer (not shown) to conduce fermentation of the seeds of fruit operatively located in the cavity 14. The fermentation conducer is received within the cavity 14. In the example embodiment the fermentation conducer is in the form of yeast.

The container 10, 10.1 includes a memory arrangement 34 for storing the location, time and temperature data.

The container 10, 10.1 further includes a data transfer module 36 for transferring any one or more of the location, time and temperature data for receipt by a remote data receiver 38. In a preferred embodiment, the remote data receiver 38 is remote from the container 10, 10.1. The data transfer module 36 is configured to transfer the data via a wireless or wired communication path 40. In the case of a wireless communication path 40, the data may be transmitted via any suitable communication protocol or standard, including Near Field Communication (NFC), Bluetooth®, Global System for Mobile Communications (GSM), Wi-Fi, or the like. It is envisaged that the system 100 be configured such that the data is automatically transmitted after it has been generated and the communication path 40 is established between the data transfer module 36 and remote data receiver 38. In this regard, it will be understood that in some instances the container 10, 10.1 could be operated in areas where no such communication path 40 exists, in which case the generated data is stored on the memory arrangement 34, and subsequently transferred to the data receiver 38 as soon as the container 10, 10.1 is moved into an area where the communication path 40 could be established.

The container 10, 10.1 also includes a microcontroller 42 which is in data communication with the geographical location tracking means 18, time module 24, temperature sensor 26, memory arrangement 34, and data transfer module 36. It will be appreciated, that although the memory arrangement 34 is indicated in FIG. 1 as a separate element, this was done merely for ease of explanation, and in some embodiments the memory arrangement 34 is incorporated into the microcontroller 42.

The container 10, 10.1 also includes an electrical power source 44 for supplying electrical power to the microcontroller 42.

The system 100 is configured for the microcontroller 42 to operatively receive the digital signal from the closure sensor 17 upon its sensing a closing of the closure 16, or in some embodiments, its sensing an opening of the closure 16. Upon receipt of the digital signal, the microcontroller 42 prompts the geographical location tracking means 18 and time module 24 to respectively generate the location data and time data. The microcontroller 42 is configured to, upon receipt of the location data and time data, have the same recorded to the memory arrangement 34. Furthermore, the microcontroller 42 may be configured to from time-to-time prompt the temperature sensor 26 to generate the temperature data, and upon receipt of the same, have the temperature data recorded to the memory arrangement 34.

The container 10, 10.1 further includes a unique identifier pertaining to the identity of the container. In the example embodiment, the unique identifier comprises a media access control address (MAC address). Here, the system 100 is further configured for the data transfer module 36 to transmit the unique identifier for receipt by the remote data receiver 38. It is to be understood that the microcontroller 42 will direct this process.

In another example embodiment, alternatively or in addition, the unique identifier may include identifying indicia. The identifying indicia may be in the form of an optical label, preferably in the form of a machine-readable optical label. Preferably, the unique identifier may include any one of the following: a one-dimensional barcode, two-dimensional barcode, a serial number, a random shaped symbol or character, and the like.

The system 100 further includes a database 46 that is remote from the container 10, 10.1 and in data communication with the remote data receiver 38. The database 46 includes first information relating to the container 48 and/or second information relating at least one party operatively in possession and/or responsible for the container 50.

The information relating to the container 48 includes any one or more selected from the group comprising a unique identifier, the location data, the time data, temperature data, and a measured weight. Furthermore, the information relating to at least one party in possession and/or responsible for the container 50 includes any one or more selected from the group comprising identification information of the party, a time and/or date when the party is in possession and/or responsible for the container, an address of an area of land associated with the party, the size of the area of land, a harvesting quota associated with the party, and banking details of the party.

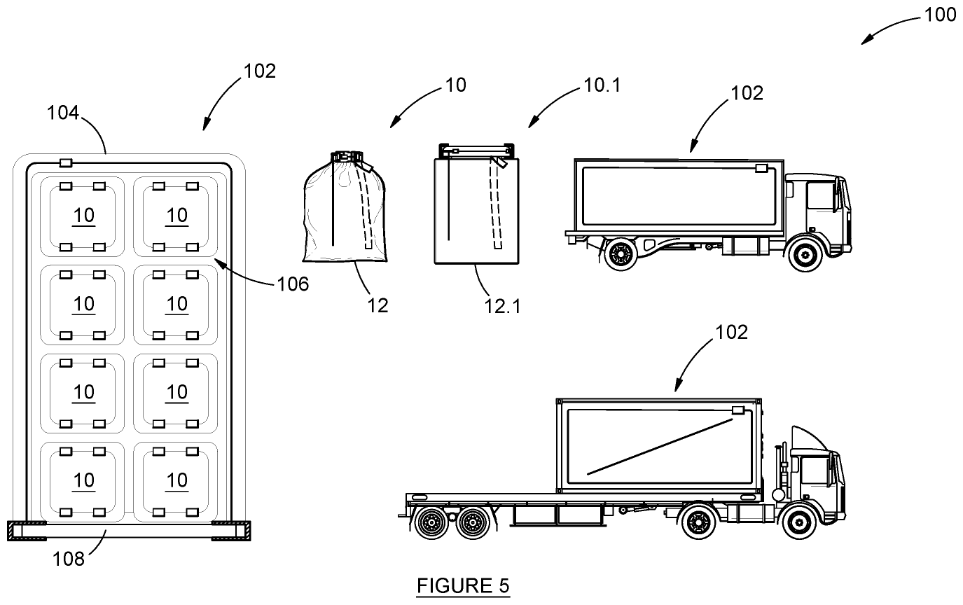

Referring to FIG. 5, in some embodiments the system 100 comprises a plurality of containers 10 and/or 10.1 for the fermentation of seeds of fruit, as described above, and at least one receptacle 102 comprising an enclosure 104 which defines a chamber 106 for receiving the plurality of containers 10, 10.1 and a closure 108 for closing the chamber 106.

The receptacle 102 is conceptually similar to the container 10, 10.1 as described above, with its enclosure 104 and chamber 106 corresponding to the container's 10, 10.1 housing 12 and cavity 14 respectively, and the container's 10, 10.1 remaining features, defined above, also being present in the receptacle 102. There is also provided for the receptable 102 to interface with the remote data receiver 38 in a similar fashion as the container 10, 10.1, and for the database 46 to include information relating to the receptacle 102 and information relating at least one party operatively in possession of the receptacle 102, which information is of a similar nature as the information relating to the container 48 and the information relating at least one party operatively in possession of the container 50.

There is, however, provided for the receptacle 102 to be substantially larger than the container 10, 10.1 in order for it to accommodate therein the plurality of containers 10, 10.1.

The receptacle 102 may be of any kind which is known in the art. In the example embodiment the receptacle 102 is in the form of a collection unit which is either fixed to a truck or is mounted onto a truck.

Referring to FIG. 6, the method of processing seeds of fruit 200 in accordance with a third aspect of the invention is shown. The method 200 comprises as a first step, and as shown at 202, recording on a database that is remote from a container, information relating to the container and at least one party in possession and/or responsible for the container. Thereafter, as shown at 204, seeds of fruit are placed in a cavity of the container. The method 200 further includes the optional step of placing a fermentation conducer in the cavity to conduce fermentation of the seeds 206, and the step of closing the cavity to form a closed tight cavity 208 that is sufficiently air-tight to provide preconditions for anaerobic fermentation of the seeds in the cavity.

The method 200 also includes the step of, on the container, generating at least location and time data 210 relating respectively to a geographical location of the container and a time when the cavity is closed. In some embodiments, temperature data may also be generated on the container at predetermined intervals relating to a temperature within the closed cavity.

The method further allows the seeds to ferment under anaerobic conditions in the closed cavity for a first period of time 212. The fermentation of the seeds under anaerobic conditions develops flavour quality and directly affects the value of the seeds. The first period of time is less than 6 weeks. More specifically, the first period of time is between 12 hours and 14 days. Even more specifically, the first period of time is between 2 and 7 days.

In the example embodiment, the closure of the cavity causes the time data, temperature data, and location data to be automatically generated.

The method also includes the further step 212 of regulating at least one climate condition in the closed cavity 214, said at least one climate condition including any one or both of a moisture quantity and pressure.

Furthermore, any one or more of the location data, time data, temperature data, and a unique identifier of the container is transferred from the container to a remote data receiver 216.

The method still further includes recording on a database that is remote from the container, information relating to the container and at least one party in possession and/or responsible for the container. The information relating to the container includes any one or more selected from the group comprising a unique identifier, the location data, the time data, and a measured weight. The information relating to at least one party in possession and/or responsible for the container includes any one or more selected from the group comprising identification information of the party, a time and/or date when the party is in possession of the container, an address of an area of land associated with the party, the size of the area of land, a harvesting quota, and banking details of the party.

The method furthermore includes the subsequent steps of opening the cavity and permitting the seeds to ferment under aerobic conditions 220 for a second period of time. The second period of time is less than 2 weeks. More specifically, the second period of time is between 1 and 9 days. Even more specifically, the second period of time is between 2 and 5 days.

Finally, the method provides for drying of the seeds 222.

It will be appreciated that each of the aerobic fermentation and the drying of the seeds steps could occur either within the cavity, or the seeds may be removed from the cavity in order for the steps to occur outside of the cavity.

A still further aspect of the method 200 provides for the recordation on the database the information relating to the at least one party in possession and/or responsible for the container when a change in the party occurs.

It is accordingly asserted that the disadvantages of the known fruit seed processing practices are overcome or at least alleviated by the present invention. The current invention provides for a system, a container and a method for processing seeds of fruit, for example cacao seeds and/or coffee beans, which permit the anaerobic fermentation of the seeds of fruit and the effective tracking of the time and location when the container was closed and opened as well as the temperature at which the seeds were fermented at. This allows for the development of flavour quality and subsequently increase the value of the seeds.

A further object address by the invention is to capture and initiate traceability data as a consequence of the post harvesting activity, thereby providing the geolocation of the point where the product has been harvested, broken (if applicable) and contained. By allocating each container a unique identity, raw products may be traced back to the farm to which the container was filled. By tracing the container and subsequently the contents of each container back to a specific farm, it is possible for companies to trace the origin of the raw products which may be used to determine whether child labour or slavery was used in its production and the impact on deforestation. The traceability of the seeds therefore addresses and at least partially alleviate exposed cases of child labour, human slavery, and wholesale environmental destruction which are known to be part of the cacao harvesting industry.

The disclosure contained herein will be especially useful in addressing the issues raised in the background to the invention. Using geolocation coordinates is the simplest and most cost-effective way of obtaining the necessary geographic information for authorities to be in a position to check whether products and commodities are deforestation-free. Combining geolocation with remote monitoring via satellite images is expected to boost the effectiveness of the EU's Regulations.

It will be appreciated by those skilled in the art that the invention is not limited to the precise details as described herein and that many variations are possible without departing from the scope of the appended claims.

The description is presented by way of example only in the cause of providing what is believed to be the most useful and readily understood description of the principles and conceptual aspects of the invention. In this regard, no attempt is made to show structural details of the invention in more detail than is necessary for a fundamental understanding of the invention. The words which have been used herein are words of description and illustration, rather than words of limitation.

1. A seed processing system suitable for processing seeds of fruit, the system comprising a seed processing container which includes:
a housing defining a cavity and an opening that is in communication with the cavity;
a closure displaceable between an open position wherein the opening is open and the seeds of fruit can be placed in or removed from the cavity, and a closed position wherein the opening is closed to form a closed cavity and the seeds of fruit cannot be placed in or removed from the cavity;
a closure sensor for sensing when the closure is displaced to its closed position, and generating closure position data in response to sensing displacement of the closure to its closed position;
a geographical location tracking module for generating location data relating to a geographical location of the container when the closure closes the opening;
a time module for generating time data relating to a time when the closure closes the opening;
a memory arrangement for storing the location and time data;
a data transfer module for transferring any one or both of the location data and time data for receipt by a remote data receiver; and
a micro-climate regulation element for regulating at least one climate condition in the closed cavity, wherein the micro-climate regulation element extends from the cavity to an outside of the container.

2. The system as claimed in claim 1, wherein the closed cavity is sufficiently air-tight to provide preconditions for anaerobic fermentation of the seeds of fruit in the cavity.

3. (canceled)

4. (canceled)

5. The system as claimed in claim 1, configured for the geographical location tracking module means generate location data relating to a geographical location of the container when the closure opens the opening.

6. The system as claimed in claim 1, configured for the time module to generate time data relating to a time when the closure opens the opening.

7. (canceled)

8. The system as claimed in claim 1, wherein the container further includes a temperature sensor for generating temperature data relating to a temperature within the closed cavity, and wherein the system is configured for the temperature sensor to measure and generate the temperature data at predetermined time intervals and for the memory arrangement to store the temperature data and the data transfer module to transfer the temperature data for receipt by the remote data receiver.

9. (canceled)

10. The system as claimed in claim 1, wherein the container comprises a unique identifier pertaining to an identity of the container, and the system is configured for the data transfer module to transfer the unique identifier for receipt by the remote data receiver.

11. (canceled)

12. The system as claimed in claim 1, wherein the container comprises a fermentation conducer to conduce fermentation of the seeds of fruit in the cavity.

13. The system as claimed in claim 1, including a database that is remote from the container and in data communication with the remote data receiver, said database including information relating to the container and at least one party in possession of the container, wherein the information relating to the container includes any one or more selected from the group comprising a unique identifier, the location data, the time data, and a measured weight, and wherein the information relating to at least one party in possession of the container includes any one or more selected from the group comprising identification information of the party, a time and/or date when the party is in possession of the container, an address of an area of land associated with the party, a size of the area of land, a harvesting quota, and banking details of the party.

14. (canceled)

15. (canceled)

16. (canceled)

17. A method of processing seeds of fruit, including the steps of:
placing seeds in a cavity of a container;
closing the cavity to form a closed cavity;
on the container, generating location data relating to a geographical location of the container when the cavity is closed;
on the container, generating time data relating to a time when the cavity is closed;
allowing the seeds to ferment in the closed cavity under anaerobic conditions for a first period of time, and
regulating at least one climate condition in the closed cavity.

18. The method as claimed in claim 17, wherein closing of the cavity forms a sufficiently air tight cavity to provide preconditions for anaerobic fermentation of the seeds therein.

19. (canceled)

20. (canceled)

21. The method as claimed in claim 17, including on the container generating temperature data relating to a temperature within the closed cavity.

22. (canceled)

23. (canceled)

24. The method as claimed in claim 17, including placing in the cavity a fermentation conducer to conduce fermentation of the seeds of fruit in the cavity.

25. The method as claimed in claim 17, including transferring from the container to a remote data receiver any one or more of the location data, time data, and a unique identifier of the container.

26. The method as claimed in claim 17, including recording on a database that is remote from the container, information relating to the container and at least one party in possession of the container, wherein the information relating to the container includes any one or more selected from the group comprising a unique identifier, the location data, the time data, and a measured weight, and wherein the information relating to at least one party in possession of the container includes any one or more selected from the group comprising identification information of the party, a time and/or date when the party is in possession of the container, an address of an area of land associated with the party, a size of the area of land, a harvesting quota, and banking details of the party.

27. (canceled)

28. (canceled)

29. (canceled)

30. (canceled)

31. (canceled)

32. (canceled)

33. The system as claimed in claim 1, wherein the at least one climate condition in the closed cavity comprises pressure, wherein and the micro-climate regulation element comprises a pressure relief valve.

34. The system as claimed in claim 1, wherein the at least one climate condition in the closed cavity comprises a moisture quantity, and wherein the micro-climate regulation element comprises an elongated wicking element.

35. The method as claimed in claim 17, wherein the at least one climate condition in the closed cavity comprises a pressure, and the method includes regulating the pressure using a pressure relief valve that extends from the cavity to an outside of the container.

36. The method as claimed in claim 17, wherein the at least one climate condition in the closed cavity comprises a moisture quantity, and the method includes regulating the moisture quantity using an elongated wicking element that extends from the cavity to an outside of the container.
